(19) United States
(12) Patent Application Publication
(10) Pub. No.: US 2002/0045468 A1
(43) Pub. Date: Apr. 18, 2002

(54) Mobile telephone call quality indicator

(76) Inventor: Reza Jalili, Bronxville, NY (US)

Correspondence Address: Reza Jalili, 1 Vincent Road #3-O, Bronxville, NY, 10708, US

(21) Appl. No.: 09/976,315

(22) Filed: Oct. 12, 2001

Related U.S. Application Data
(60) Provisional application No. 60/239,810, filed on Oct. 12, 2000.

(51) Int. Cl. H04M 1/00

(52) U.S. Cl. 455/567; 455/412

(57) ABSTRACT

An audible pre-recorded message announces call quality and call termination so that a mobile phone user can be alerted when the other party cannot hear him/her and also when the connection has been terminated. A button on a telephone is used to signal a bad connection to the other party.

### CROSS-REFERENCE TO RELATED APPLICATION

This application is based on and claims priority from U.S. Provisional Patent Application Serial No. 60/239,810 filed on Oct. 12, 2000.

### FIELD OF THE INVENTION

The present invention is directed generally to mobile telephones.

### BACKGROUND OF THE INVENTION

Cellular and digital mobile telephone devices have become widely used over the past several years. As much as the field has advanced, the quality of transmissions and receptions is not always perfect and therefore some phone conversations are abruptly terminated while one or both parties is speaking. Present mobile phones have visual indicators that show the status of calls and offer other features such as address books and email.

Sometimes a conversation is of poor quality and reception is intermittent. In such cases, one or both parties yell back and forth to see if the other can hear.

### SUMMARY OF THE INVENTION

The present invention solves the problem of knowing when a communication channel is of poor quality and of knowing when a communication channel has been lost or terminated.

According to one aspect of the present invention, an audio announcement pre-recorded and resident on the mobile phone device will announce the termination of each call.

According to another aspect of the present invention, an audio announcement pre-recorded and resident on the mobile phone device will announce the potential loss of communications upon receipt of a “Bad-Connection” signal.

Accordingly, one feature of the present invention is to provide a means for indicating the termination of a phone call when visual inspection of any indicators is not convenient or possible.

Another feature is to provide a service for mobile phone users that allows for the generation, transmission, reception, and processing of a “Bad-Connection” distress signal, where said distress signal is relatively impervious to transmission errors.

Another feature is to provide a means for indicating that the other party may not hear the user of a phone when visual inspection of any indicators is not convenient or possible.

Another feature is to provide a means for indicating that the user of a phone is having difficulty hearing the other party when visual indicators are not convenient or useful.

Additional advantages and novel features of the invention will be set forth in, and become apparent to those skilled in the art from the description which follows.

### BRIEF DESCRIPTION OF THE DRAWINGS

For a fuller understanding of the invention, reference is had to the following description taken in connection with the accompanying drawings, in which:

FIG. 1. Shows a sample phone device with a “Bad-Connection” button.

FIG. 2. Shows a sample protocol for a “Bad-Connection” service

### DETAILED DESCRIPTION OF THE EMBODIMENTS OF THE INVENTION

Embodiments of a system built in accordance with the present invention will now be described with continued reference to the Figures.

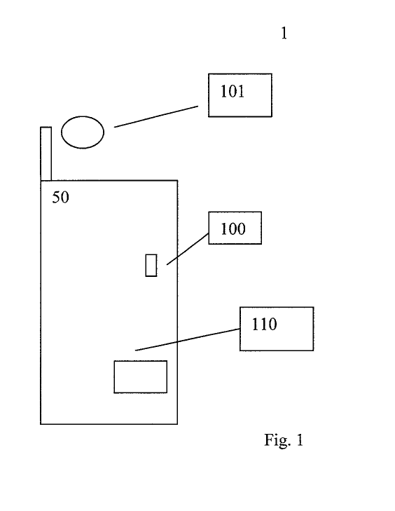

An example of a distress button (100) on a telephone (50) is shown in FIG. 1. The distress button (100) causes to be generated a distress signal (101) of some particular digital bit-pattern (110) stored or generated within the telephone (50) which would be relatively robust in a noisy channel and which would have a good chance of being delivered recognizably to a receiver. The distress signal (110) can be produced alternatively, by pressing a known combination of keypad buttons. The distress signal (101) is transmitted by the telephone (50).

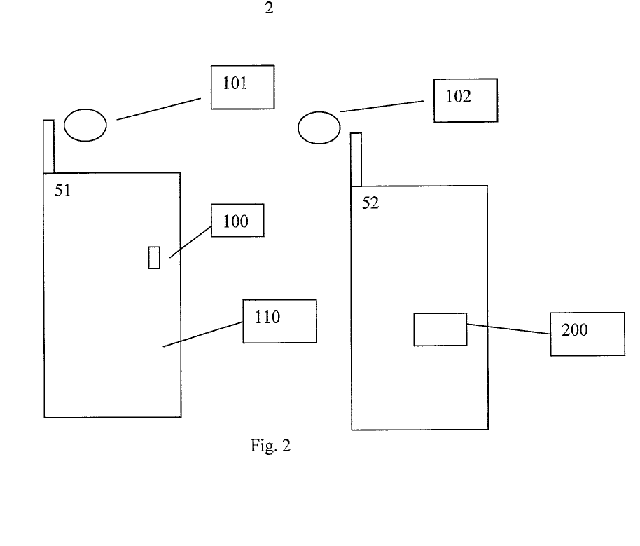

FIG. 2 shows a diagram of a service for alerting a mobile phone user of a bad connection. Central office or intermediate digital call station (300) receives a distress signal (101) from party 1 (51) and generates a fresh distress signal (102) for the second party (52). Party 2 (52) indicates the bad connection status using an audio recording (200) stored or generated in telephone (52). Optionally, and alternatively, a visual or vibratory indication is made.

Although illustrative embodiments of the invention have been described herein, it is to be understood that modifications and variations thereof may occur to one having ordinary skill in the relevant art. The invention should therefore be considered to include all such modifications and variations within the fair spirit and scope of the invention.

I claim:

1. A mobile telephone device with means for audio indication of call status.

2. A mobile telephone device as in claim 1 wherein said audio indication is a pre-recorded audio message stored in said mobile telephone device.

3. A mobile telephone device as in claim 1 wherein said means for audio indication selectively plays a pre-recorded audio based on the call status, whereby said audio indication is triggered by call termination.

4. A mobile telephone device as in claim 3 wherein said audio indication is played upon reception of a trigger signal.

5. A mobile telephone device as in claim 3 wherein said trigger signal is received from the mobile telephone communications service provider.

6. A mobile telephone device with means for generating a “bad connection” signal within said mobile telephone device.
